(19) United States
(12) Patent Application Publication
(10) Pub. No.: US 2004/0075951 A1
(43) Pub. Date: Apr. 22, 2004

(54) Head drum assembly for tape recorder and method for manufacturing same

(76) Inventors: Chung-hum Baik, Suwon-city (KR); Seung-woo Lee, Suwon-city (KR); Tae-gil Kang, Suwon-city (KR)

Correspondence Address: Roylance Abrams Berdo & Goodman, 6th Floor, 1300 19th Street, NW, Washington, DC, 20036, US

(21) Appl. No.: 10/667,500

(22) Filed: Sep. 23, 2003

(30) Foreign Application Priority Data
Oct. 21, 2002 (KR) 2002-64348

(51) Int. Cl. G11B 5/52

(52) U.S. Cl. 360/271.7

(57) ABSTRACT

A head drum assembly of a tape recorder is disclosed. A rotor case is directly bonded to a rotary drum, a spacer interposed between a magnet yoke and a stator coil of a motor stator is removed, and a predetermined gap is formed between the magnet yoke and the stator coil. As a result, it is possible to remove a rotor bush and a spacer from the component list of the conventional construction and to exclude the assembling steps thereof, whereby assembling the head drum assembly is easier and the cost of manufacturing is reduced.

### PRIORITY

This application claims priority under 35 U.S.C. § 119 to an application entitled “A Head Drum Assembly of Tape Recorder” filed in the Korean Intellectual Property Office on Oct. 21, 2002 and assigned Ser. No. 2002-64348, the contents of which are incorporated herein by reference.

### BACKGROUND OF THE INVENTION

1. Field of the Invention

The present invention relates to a head drum assembly for a tape recorder such as a VCR or camcorder, and in particular, to a head drum assembly having a motor rotor and a motor stator which are improved in construction.

2. Description of the Related Art

In general, tape recorders such as VCRs and camcorders are provided with a head drum assembly that is mounted for high-speed rotation. This enables information to be recorded and reproduced by the scanning of a magnetic head in relation to a magnetic tape. As shown in FIG. 1, which is a cross-sectional schematic view of a head drum assembly, the head drum assembly comprises: a rotary drum 10, which rotatably supports a magnetic head H for recording and reproducing information by scanning a running magnetic tape; a fixed drum 20, which is press-fitted onto a lower part of a shaft 30 engaged in a central axial bore of the rotary drum 10; a motor stator 50 mounted in the fixed drum 20; and a motor rotor 40 mounted opposite to the motor stator 50 and engaged with the rotary drum 10. In the drawing, reference numeral 60 indicates a bearing for supporting the rotary drum 10 to for rotation in relation to the shaft 30.

Referring to FIG. 2, which is a detailed partial view of the head drum assembly, the conventional head drum assembly having the construction as described above has a problem in that the number of components is large, thereby increasing manufacturing costs and making it more difficult to assemble. Increased costs and difficulty in assembly can be attributed to the motor rotor 40, in which the internal diametric part of a rotor case 42 is supported by a rotor bush 41 engaged onto the outer circumferential portion of the lower part of the rotary drum 10.

In addition, the motor stator 50 should maintain an appropriate magnetizing force with magnet yoke 51, so that the magnetic head H processes signals by forming a magnetic field. Therefore, a plastic spacer 53 is interposed and bonded between the magnet yoke 51 and a stator coil 52 so that a predetermined gap can be formed and maintained between the magnet yoke 51 and the stator coil 52. As a result, there is a high number of parts, causing manufacturing costs and assembly steps to increase.

### SUMMARY OF THE INVENTION

An object of the present invention is to substantially solve at least the above problems and/or disadvantages and to provide at least the advantages described below. Accordingly, it is an object of the present invention to provide a head drum assembly for a tape player/recorder comprising a rotary drum which rotatably supports a magnetic head for recording and reproducing information by scanning a running magnetic tape, a fixed drum press-fitted onto the lower part of a shaft engaged in a central axial bore of the rotary drum parallel to the rotary drum, a motor stator provided in the fixed drum, and a motor rotor provided opposite to the motor stator. The motor rotor is connected to the rotary drum, and a rotor case of the motor rotor is directly bonded to an outer circumferential surface of the rotary drum.

It is a further object of the invention to provide a method for manufacturing a head drum assembly for a tape player/recorder comprising press fitting a fixed drum onto a lower part of a shaft engaged in a central axial bore of a rotary drum parallel to the rotary drum, wherein the fixed drum comprises a motor stator, and wherein the rotary drum rotatably supports a magnetic head for recording and reproducing information by scanning a running magnetic tape. The method further comprises connecting a motor rotor to the rotary drum, wherein a rotor case of the motor rotor is directly bonded to an outer circumferential surface of the rotary drum.

### BRIEF DESCRIPTION OF THE DRAWINGS

The above and other objects, features and advantages of embodiments of the present invention will be more apparent from the following detailed description taken with reference to the accompanying drawings, in which:

FIG. 1 is a cross-sectional schematic view of a conventional head drum assembly of a tape recorder;

FIG. 2 is a detailed partial cross-sectional schematic view of the main part of the head drum assembly shown in FIG. 1;

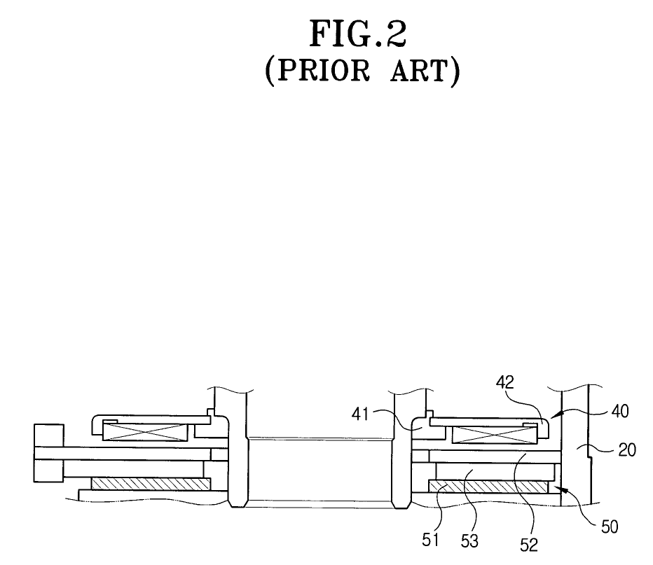

FIG. 3 is a cross-sectional schematic view which shows a head drum assembly of a tape recorder according to an embodiment of the present invention; and

FIG. 4 is a detailed partial cross-sectional schematic view of the main part of the head drum assembly shown in FIG. 3.

### DETAILED DESCRIPTION OF THE PREFERRED EMBODIMENT

Hereinbelow, a head drum assembly of a tape recorder according to an embodiment of the present invention will be described in detail with reference to accompanying drawings.

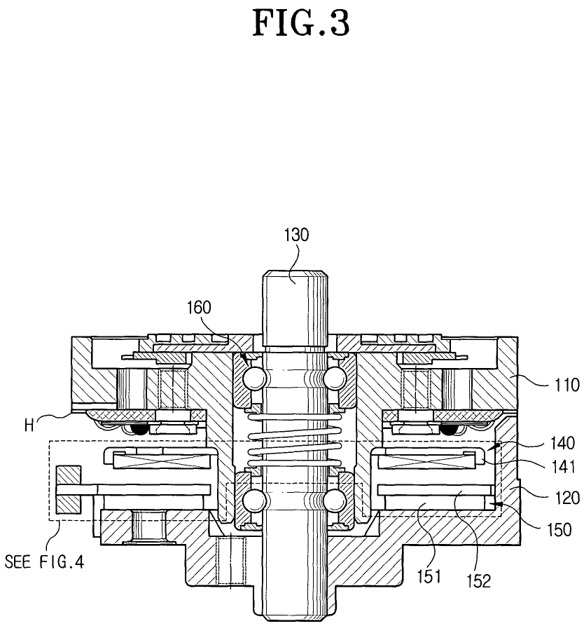

Referring to FIG. 3, the head drum assembly 100 of a tape recorder according to an embodiment of the present invention comprises: a rotary drum 110, which rotatably supports a magnetic head H for recording and reproducing information by scanning a running magnetic tape; a fixed drum 120 press-fitted onto the lower part of a shaft 130 engaged in a central axial bore of the rotary drum 110 parallel to the rotary drum 110; a motor stator 150 provided in the fixed drum 120; and a motor rotor 140 provided opposite to the motor stator 150. The motor rotor 140 is connected to the rotary drum 110, and a rotor case 141 of the motor rotor 140 is directly bonded to an outer circumferential surface of the rotary drum 110.

According to another aspect of the illustrated embodiments of the present invention, the head drum assembly further comprises a magnet yoke 151 and a stator coil 152 provided in the motor stator 150, wherein the magnet yoke 151 and the stator coil 152 are sequentially stacked on the fixed drum 120 while a constant gap G1 is maintained between them.

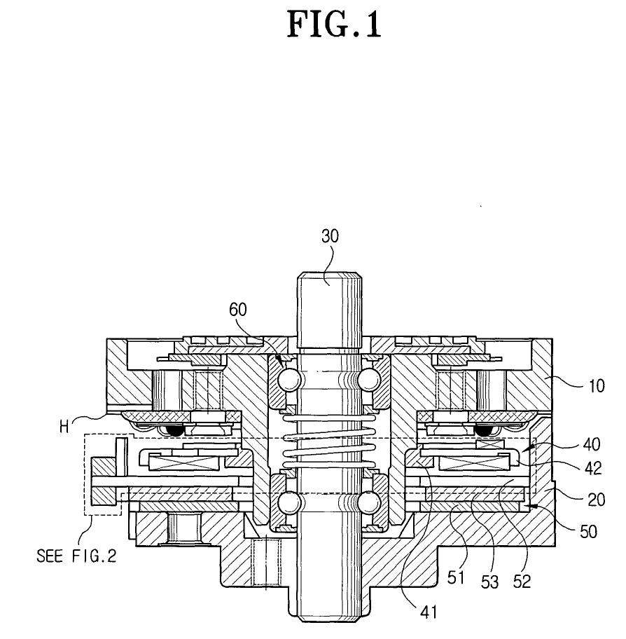

According to the above-mentioned construction of the head drum assembly according to an embodiment of the present invention, because the rotor case 141 of the motor rotor 140 is directly bonded to the outer circumferential surface of the lower part of the rotary drum 110, the rotor bush 41 (see FIG. 1) in the conventional construction can be removed (and hence its assembly step eliminated), whereby manufacturing costs can be reduced.

In addition, because a predetermined gap is formed between the magnet yoke 151 and the stator coil 152 provided in the motor stator 150, a head drum assembly built in accordance with an embodiment of the present invention, does not require the spacer 53 (see FIG. 1) used in the conventional construction. Since the spacer 53 is eliminated, its bonding step can be removed, whereby the manufacturing steps and costs are reduced.

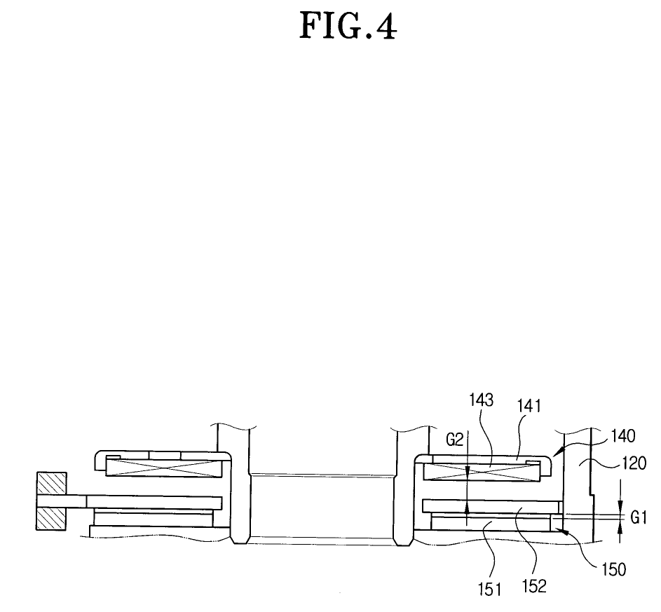

Referring to FIG. 4, it can be shown that constructing a motor stator 150 in accordance with an embodiment of the present invention provides motor stator characteristics identical to a conventional one. FIG. 4 is detailed partial cross-sectional view of the main part of the head drum assembly shown in FIG. 3. The conventional motor stator characteristics are maintained if a substantially constant gap G2, formed between the motor rotor 140 and the motor stator 150, is adjusted to be in the range of about 0.3 mm to 0.4 mm, (preferably about 0.36 mm) or the magnetizing force of the rotor magnet 143 is controlled (for example, by lowering the magnetizing force), and a substantially constant gap G1 between the magnetic yoke 151 and the stator coil 152 is maintained within the range of 0 to 0.03 mm.

Consequently, it becomes possible to remove the rotor bush 41 and the spacer 53 from the component list in a head drum assembly of a tape recorder built in accordance within an embodiment of the present invention. Further, the manufacturing steps involving those parts can be eliminated. Thus, the cost of manufacturing the head drum assembly can be subsequently reduced. As described above, a head drum assembly of a tape recorder built in accordance with an embodiment of the present invention can be assembled with less components and reduced manufacturing steps. Thus, assembling the head drum assembly is easier and the cost of manufacturing is lower.

While an embodiment of the present invention has been shown and described, the present invention is not limited to the embodiment described above and variant embodiments can be made by those skilled in the art without departing from the spirit and scope of the invention as defined by the appended claims.

1. A head drum assembly for a tape player/recorder comprising:
a rotary drum, which rotatably supports a magnetic head for recording and reproducing information by scanning a running magnetic tape;
a fixed drum press-fitted onto the lower part of a shaft engaged in a central axial bore of the rotary drum parallel to the rotary drum;
a motor stator provided in the fixed drum; and
a motor rotor provided opposite to the motor stator, the motor rotor being connected to the rotary drum, and a rotor case of the motor rotor being directly bonded to an outer circumferential surface of the rotary drum.

2. The head drum assembly for a tape player/recorder according to claim 1, wherein the motor stator comprises:
a magnetic yoke; and
a stator coil, wherein a substantially constant first gap is maintained between the magnetic yoke and stator coil.

3. The head drum assembly for a tape player/recorder according to claim 1, wherein a substantially constant second gap is maintained between the motor rotor and motor stator.

4. The head drum assembly for a tape player/recorder according to claim 3, wherein the substantially constant second gap is in the range of 0.3 mm to 0.4 mm.

5. The head drum assembly for a tape player/recorder according to claim 3, wherein the substantially constant second gap is about 0.36 mm.

6. The head drum assembly for a tape player/recorder according to claim 2, wherein the substantially constant first gap is within the range of 0 to 0.03 mm.

7. The head drum assembly for a tape player/recorder according to claim 2, further comprising a rotor magnet, and wherein a magnetizing force of the rotor magnet is controlled.

8. The head drum assembly for a tape player/recorder according to claim 7, wherein the magnetic force of the rotor magnet is controlled to be lower than a conventional motor stator.

9. A method for manufacturing a head drum assembly for a tape player/recorder comprising:
press fitting a fixed drum onto a lower part of a shaft engaged in a central axial bore of a rotary drum parallel to the rotary drum, wherein the fixed drum comprises a motor stator, and wherein the rotary drum rotatably supports a magnetic head for recording and reproducing information by scanning a running magnetic tape; and
connecting a motor rotor to the rotary drum, wherein a rotor case of the motor rotor is directly bonded to an outer circumferential surface of the rotary drum.

10. The method for manufacturing a head drum assembly for a tape player/recorder according to claim 9, wherein the motor stator comprises:
a magnetic yoke; and
a stator coil, wherein a substantially constant first gap is maintained between the magnetic yoke and stator coil.

11. The method for manufacturing a head drum assembly for a tape player/recorder according to claim 9, wherein a substantially constant second gap is maintained between the motor rotor and motor stator.

12. The method for manufacturing a head drum assembly for a tape player/recorder according to claim 11, wherein the substantially constant second gap is in the range of 0.3 mm to 0.4 mm.

13. The method for manufacturing a head drum assembly for a tape player/recorder according to claim 11, wherein the substantially constant second gap G2 is about 0.36 mm.

14. The method for manufacturing a head drum assembly for a tape player/recorder according to claim 10, wherein the substantially constant first gap is within the range of 0 to 0.03 mm.

15. The method for manufacturing a head drum assembly for a tape player/recorder according to claim 10, wherein the head drum assembly further comprises a rotor magnet, and wherein a magnetizing force of the rotor magnet is controlled.

16. The method for manufacturing a head drum assembly for a tape player/recorder according to claim 15, wherein the magnetic force of the rotor magnet is controlled to be lower than a conventional motor stator.
